(19) United States
(12) Patent Application Publication
(10) Pub. No.: US 2025/0215545 A1
(43) Pub. Date: Jul. 3, 2025

(54) COLD-ROLLED STEEL SHEET

(71) Applicant: NIPPON STEEL CORPORATION, Tokyo (JP)

(72) Inventors: Takuya NISHIO, Tokyo (JP); Shintaro OKURA, Tokyo (JP); Yu MATSUMOTO, Tokyo (JP); Masafumi AZUMA, Tokyo (JP); Kojiro AKIBA, Tokyo (JP)

(73) Assignee: NIPPON STEEL CORPORATION, Tokyo (JP)

(21) Appl. No.: 18/835,256

(22) PCT Filed: Dec. 22, 2022
(86) PCT No.: PCT/JP2022/047431

§ 371 Date: Aug. 1, 2024

(30) Foreign Application Priority Data
Feb. 9, 2022 (JP) 2022-018404

(51) Int. Cl. C22C 38/50; C21D 1/22; C21D 1/76; C21D 6/00; C21D 8/02; C21D 9/46; C22C 38/00; C22C 38/02; C22C 38/06; C22C 38/38; C22C 38/44; C22C 38/46; C22C 38/48; C22C 38/54; C23C 2/06; C23C 2/28; C23C 2/40

(52) U.S. Cl. CPC C22C 38/50; C21D 1/22; C21D 1/76; C21D 6/002; C21D 6/005; C21D 6/008; C21D 8/0205; C21D 8/0226; C21D 8/0236; C21D 8/0273; C21D 9/46; C22C 38/001; C22C 38/002; C22C 38/02; C22C 38/06; C22C 38/38; C22C 38/44; C22C 38/46; C22C 38/48; C22C 38/54; C23C 2/06; C23C 2/28; C23C 2/40; C21D 2211/001; C21D 2211/002; C21D 2211/005; C21D 2211/008

(57) ABSTRACT

This cold-rolled steel sheet has a predetermined chemical composition, in which a metallographic structure at a ¼ depth position, which is a ¼ thickness position from a surface, contains, by volume percentage, retained austenite: more than 1.0% and less than 10.0%, tempered martensite: 80.0% or more, ferrite and bainite: 0% or more and 15.0% or less in total, and martensite: 0% or more and 3.0% or less, and an average grain size of a first grain counted in a sheet thickness direction from the surface when viewed at a cross section parallel to a rolling direction and parallel to the sheet thickness direction is 20.0 μm or less, and an average grain size of the first grain when the surface is viewed in a plan view is 30.0 μm or less.

### TECHNICAL FIELD OF THE INVENTION

The present invention relates to a cold-rolled steel sheet. Priority is claimed on Japanese Patent Application No. 2022-018404, filed Feb. 9, 2022, the content of which is incorporated herein by reference.

### RELATED ART

Today, as industrial technology fields are highly divided, materials used in each technology field require special and advanced performance. In particular, with regard to steel sheets for a vehicle, in order to reduce a weight of a vehicle body and improve fuel efficiency in consideration of the global environment, there is a significantly increasing demand for cold rolled high tensile strength steel sheets having a small sheet thickness and excellent formability. Among the steel sheets for a vehicle, particularly for cold-rolled steel sheets used for vehicle body frame components, high strength is required, and furthermore, high formability for wide applications is required.

In addition, since vehicle components are formed by pressing or the like, the vehicle components are required to have excellent formability (for example, uniform elongation or bendability) even with high strength.

In addition, since susceptibility to hydrogen embrittlement increases with high-strengthening, it is also important to have excellent hydrogen embrittlement resistance.

Therefore, in recent years, examples of properties required for a steel sheet for a vehicle include a tensile strength (TS) of 1,310 MPa or more, a uniform elongation of 4.0% or more, R/t, which is a ratio of a limit bend (minimum bend radius) R in 90° V-bending to a sheet thickness, of 5.0 or less, and superior hydrogen embrittlement resistance.

Although it is effective to provide a structure containing ferrite in order to secure ductility such as uniform elongation, a secondary phase needs to be hardened to obtain a strength of 1,310 MPa or more with the structure containing ferrite. However, a hard secondary phase deteriorates hole expansibility.

As a technique for improving hole expansibility of a high strength steel sheet, a steel sheet containing tempered martensite as a primary phase has been proposed (refer to, for example, Patent Documents 1 and 2). Patent Documents 1 and 2 describe that the hole expansibility is excellent when a microstructure is tempered martensite single structure.

However, the invention of Patent Document I has a tensile strength as low as less than 1,310 MPa. Therefore, in a case of aiming for further high-strengthening, it is necessary to further improve workability that deteriorates accordingly. In addition, although the invention of Patent Document 2 can achieve a strength as high as 1,310 MPa or more, since the steel sheet is cooled to near room temperature during cooling during quenching, there is a problem in that a volume percentage of retained austenite is small and high uniform elongation cannot be obtained.

In addition, Patent Document 3 proposes a steel sheet using a transformation induced plasticity (TRIP) effect caused by retained austenite as a technique for achieving both high-strengthening and high formability.

In addition, since the steel sheet of Patent Document 3 has ferrite, it is difficult to obtain a strength as high as 1,310 MPa or more, and a strength difference in the structure causes deterioration in hole expansion formability.

In addition, Patent Document 4 describes that a high strength cold-rolled steel sheet having a tensile strength (TS) of 1,310 MPa or more, a uniform elongation of 5.0% or more, a ratio (R/t) of a limit bend radius R in 90° V-bending to a sheet thickness t of 5.0 or less, and superior hydrogen embrittlement resistance is obtained by softening of a surface layer and refinement of a hard phase of a surface layer area through dew point control during annealing while setting a structure (metallographic structure) at a ¼ thickness position from a surface to a structure primarily containing tempered martensite including retained austenite.

However, in recent years, there has been a demand for a further improvement in properties, particularly, an improvement in hydrogen embrittlement resistance.

### PRIOR ART DOCUMENT

### Patent Document

Patent Document 1: Japanese Unexamined Patent Application, First Publication No. 2009-30091

Patent Document 2: Japanese Unexamined Patent Application, First Publication No. 2010-215958

Patent Document 3: Japanese Unexamined Patent Application, First Publication No. 2006-104532

Patent Document 4: PCT International Publication No. WO2019/181950

### DISCLOSURE OF THE INVENTION

### Problems to be Solved by the Invention

As described above, in recent years, regarding steel sheets having a high strength, which is a tensile strength (TS) of 1,310 MPa or more, there has been a demand for steel sheets having higher formability and hydrogen embrittlement resistance.

The present invention has been made to solve the above problems, and an object thereof is to provide a cold-rolled steel sheet having excellent formability, which is an issue with high strength steel sheets, and excellent hydrogen embrittlement resistance,

Here, the cold-rolled steel sheet includes not only a cold-rolled steel sheet having no plating layer on a surface but also a hot-dip galvanized steel sheet and a hot-dip galvannealed steel sheet.

### Means for Solving the Problem

The present inventors conducted a detailed investigation on the effects of a chemical composition, a metallographic structure, and manufacturing conditions on mechanical properties of a cold-rolled steel sheet. As a result, it was found that strength, formability, and hydrogen embrittlement resistance can be obtained at high levels by allowing a metallographic structure to be a structure primarily containing tempered martensite containing a predetermined amount or more of retained austenite and controlling shapes of grains in an outermost surface.

The present invention has been made in view of the above findings. The gist of the present invention is as follows.

[1] A cold-rolled steel sheet according to an aspect of the present invention includes, as a chemical composition, by mass %: C: more than 0.140% and less than 0.400%; Si: less than 1.00%; Mn: more than 2.00% and less than 3.50%; P: 0.100% or less; S: 0.010% or less; Al: 0.100% or less; N: 0.0100% or less; Ti: 0% or more and less than 0.050%; Nb: 0% or more and less than 0.050%; V: 0% or more and 0.50% or less; Cu: 0% or more and 1.00% or less; Ni: 0% or more and 1.00% or less; Cr: 0% or more and 1.00% or less; Mo: 0% or more and 0.50% or less; B: 0% or more and 0.0100% or less; Ca: 0% or more and 0.0100% or less; Mg: 0% or more and 0.0100% or less; REM: 0% or more and 0.0500% or less; Bi: 0% or more and 0,050% or less; and a remainder: Fe and impurities, in which a metallographic structure at a ¼ depth position, which is a ¼ thickness position from a surface, contains, by volume percentage, retained austenite: more than 1.0% and less than 10.0%, tempered martensite: 80.0% or more, ferrite and bainite: 0% or more and 15.0% or less in total, and martensite: 0% or more and 3.0% or less, and an average grain size of grains firstly counted in a sheet thickness direction from the surface when viewed at a cross section parallel to a rolling direction and parallel to the sheet thickness direction is 20.0 μm or less, and an average grain size of the grains when the surface is viewed in a plan view is 30.0 μm or less.

[2] In the cold-rolled steel sheet according to [1], a tensile strength may be 1,310 MPa or more, a uniform elongation may be 4.0% or more, and R/t, which is a ratio of a limit bend R to a sheet thickness at 90° V-bending may be 5.0 or less.

[3] In the cold-rolled steel sheet according to [1] or [2], the chemical composition may contain, by mass %, one or two or more selected from Ti: 0.001% or more and less than 0.050%, Nb: 0.001% or more and less than 0.050%, V: 0.01% or more and 0.50% or less, Cu: 0.01% or more and 1.00% or less, Ni: 0.01% or more and 1.00% or less, Cr: 0.01% or more and 1.00% or less, Mo: 0.01% or more and 0.50% or less, B: 0.0001% or more and 0.0100% or less, Ca: 0.0001% or more and 0.0100% or less, Mg: 0.0001% or more and 0.0100% or less, REM: 0.0005% or more and 0.0500% or less, and Bi: 0.0005% or more and 0.050% or less.

[4] In the cold-rolled steel sheet according to [1] or [2], a hot-dip galvanized layer may be formed on the surface.

[5] In the cold-rolled steel sheet according to [3], a hot-dip galvanized layer may be formed on the surface.

[6] In the cold-rolled steel sheet according to [4], the hot-dip galvanized layer may be a hot-dip galvannealed layer.

[7] In the cold-rolled steel sheet according to [5], the hot-dip galvanized layer may be a hot-dip galvannealed layer.

### EFFECTS OF THE INVENTION

According to the above-described aspect of the present invention, it is possible to provide a cold-rolled steel sheet having excellent formability and excellent hydrogen embrittlement resistance.

### Embodiments of the Invention

A chemical composition and a metallographic structure of a cold-rolled steel sheet according to an embodiment of the present invention (hereinafter, sometimes simply referred to as the steel sheet according to the present embodiment), and rolling and annealing conditions and the like in a manufacturing method capable of efficiently, stably, and economically manufacturing the steel sheet will be described below in detail.

The steel sheet according to the present embodiment includes not only a cold-rolled steel sheet having no plating layer, but also a hot-dip galvanized steel sheet having a hot-dip galvanized layer on a surface of a base steel sheet or a hot-dip galvannealed steel sheet having a hot-dip galvannealed layer on a surface of a base steel sheet, and main conditions described below are common to the hot-dip galvanized steel sheet and the hot-dip galvannealed steel sheet.

### Chemical Composition

First, the chemical composition of the steel sheet according to the present embodiment will be described. Hereinafter, “%” indicating an amount of each element in the chemical composition means “mass %” unless otherwise specified.

### [C: More Than 0.140% and Less Than 0.400%]

When a C content is 0.140% or less, it becomes difficult to obtain the above-described metallographic structure, and a target tensile strength cannot be achieved. In addition, bendability decreases. Therefore, the C content is set to more than 0.140%. The C content is preferably more than 0.160%, and more preferably more than 0.180%.

On the other hand, when the C content is 0.400% or more, weldability deteriorates and the bendability deteriorates. In addition, hydrogen embrittlement resistance also deteriorates. Therefore, the C content is set to less than 0.400%. The C content is preferably less than 0.350%, and more preferably less than 0.300%.

### [Si: Less Than 1.00%]

When a Si content is 1.00% or more, austenitic transformation during heating in an annealing step slows down, and there are cases where transformation from ferrite to austenite does not occur sufficiently. In this case, an excessive amount of ferrite. remains in a structure after annealing, and a target tensile strength cannot be achieved, so that the bendability deteriorates. In addition, when the Si content is 1.00% or more, surface properties of the steel sheet deteriorate. Furthermore, chemical convertibility and platability significantly deteriorate. Therefore, the Si content is set to less than 1.00%.

A lower limit of the Si content is not limited and may be 0%. However, Si is an element effective for forming an internal oxide in a surface layer area of the steel sheet, and refining a metallographic structure of the surface layer area by a pinning effect of the internal oxide. In addition, Si is an element useful for increasing a strength of the steel sheet by solid solution strengthening. In addition, Si suppresses the generation of cementite, and is thus an element effective in promoting the concentration of C in austenite and generating retained austenite after annealing. In a case where these effects are obtained, the Si content is preferably set to 0.01% or more. The Si content is more preferably 0.05% or more, even more preferably 0.10% or more, and still more preferably 0.50% or more.

### [Mn: More Than 2.00% and Less Than 3.50%]

Mn has an action of improving hardenability of steel and is an element effective for obtaining the above-described metallographic structure. When a Mn content is 2.00% or less, it becomes difficult to obtain the above-described metallographic structure. In addition, in this case, a sufficient tensile strength cannot be obtained. In addition, Mn is an element effective for forming an internal oxide, and refining the metallographic structure of the surface layer area by a pinning effect of the internal oxide. In order to obtain these effects, the Mn content is set to more than 2.00%. The Mn content is preferably more than 2.20%, and more preferably more than 2.50%.

On the other hand, when the Mn content is 3.50% or more, an effect of improving the hardenability is diminished due to segregation of Mn, and a material cost increases. Therefore, the Mn content is set to less than 3.50%. The Mn content is preferably less than 3.25%, and more preferably less than 3.00%.

### [P: 0.100% or Less]

P is an element contained in steel as an impurity and is an element that segregates at grain boundaries and embrittles steel. Therefore, a P content is preferably as small as possible and may be 0%. However, in consideration of a time and a cost for removing P, the P content is set to 0.100% or less. The P content is preferably 0.020% or less, and more preferably 0.015% or less.

### [S: 0.010% or Less]

S is an element contained in steel as an impurity and is an element that forms sulfide-based inclusions and deteriorates the bendability. Therefore, a S content is preferably as small as possible and may be 0%. However, in consideration of a time and a cost for removing S, the S content is set to 0.010% or less. The S content is preferably 0.005% or less, more preferably 0.003% or less, and even more preferably 0.001% or less.

### [Al: 0.100% or Less]

On the other hand, when an Al content is too high, not only are surface. defects caused by alumina likely to occur, but also a transformation point significantly increases, so that a volume percentage of ferrite increases. In this case, it becomes difficult to obtain the above-mentioned metallographic structure, and a sufficient tensile strength cannot be obtained. Therefore, the Al content is set to 0.100% or less. The Al content is preferably 0.050% or less, more preferably 0.040% or less, and even more preferably 0.030% or less.

Al is an element having an action of deoxidizing molten steel. In the steel sheet according to the present embodiment, since Si having a deoxidizing action like Al is contained, Al does not necessarily have to be contained, and the Al content may be 0%. However, in a case where Al is contained for the purpose of deoxidation, the Al content is preferably 0.005% or more, and more preferably 0.010% or more for reliable deoxidation. In addition, Al has an action of enhancing stability of austenite like Si and is an effective element for obtaining the above-described metallographic structure. Therefore, Al may be contained from this point of view.

### [N: 0.0100% or Less]

N is an element contained in steel as an impurity and is an element that forms a coarse precipitate and deteriorates the bendability. Therefore, a N content is set to 0.0100% or less. The N content is preferably 0.0060% or less, and more preferably 0.0050% or less. The N content is preferably as small as possible, and may be 0%.

The steel sheet according to the present embodiment contains the above-described elements and a remainder is Fe and impurities, and the steel sheet may further contain one or two or more of elements listed below that affect the strength and the bendability as optional elements. However, since these elements do not necessarily have to be contained, lower limits of all thereof are 0%.

### [Ti: 0% or More and Less Than 0.050%]

### [Nb: 0% or More and Less Than 0.050%]

### [V: 0% or More and 0.50% or Less]

### [Cu: 0% or More and 1.00% or Less]

Ti, Nb, V, and Cu are elements having an action of improving the strength of the steel sheet by precipitation hardening. Therefore, these elements may be contained. In order to sufficiently obtain the above effects, it is preferable that a Ti content and a Nb content are each set to 0.001% or more, and a V content and a Cu content are each set to 0.01% or more. The Ti content and the Nb content are each more preferably 0.005% or more, and the V content and the Cu content are each more preferably 0.05% or more. It is not essential to obtain the above effects. Therefore, it is not necessary to particularly limit lower limits of the Ti content, the Nb content, the V content, and the Cu content, and the lower limits thereof are 0%.

On the other hand, when these elements are excessively contained, a recrystallization temperature rises, the metallographic structure of the cold-rolled steel sheet becomes non-uniform, and the bendability is impaired. Therefore, in a case where these elements are contained, the Ti content is set to less than 0.050%, the Nb content is set to less than 0.050%, the V content is set to 0.50% or less, and the Cu content is set to 1.00% or less. The Ti content is preferably less than 0.030%, and more preferably less than 0.020%. The Nb content is preferably less than 0.030%, and more preferably less than 0.020%. The V content is preferably 0.30% or less. The Cu content is preferably 0.50% or less.

### [Ni: 0% or More and 1.00% or Less]

### [Cr: 0% or More and 1.00% or Less]

### [Mo: 0% or More and 0.50% or Less]

### [B: 0% or More and 0.0100% or Less]

Ni, Cr, Mo, and B are elements that improve the hardenability of steel and contribute to high-strengthening, and are effective elements for obtaining the above-described metallographic structure. Therefore, these elements may be contained. In order to sufficiently obtain the above effects, it is preferable that a Ni content, a Cr content, and a Mo content are each set to 0.01% or more, and/or a B content is set to 0.0001% or more. More preferably, the Ni content, the Cr content, and the Mo content are each 0.05% or more, and the B content is 0.0010% or more. It is not essential to obtain the above effects. Therefore, it is not necessary to particularly limit lower limits of the Ni content, the Cr content, the Mo content, and the B content, and the lower limits thereof are 0%.

On the other hand, even if these elements are excessively contained, the effect of the above-described action is saturated, which is uneconomical. Therefore, in a case where these elements are contained, the Ni content and the Cr content are each set to 1.00% or less, the Mo content is set to 0.50% or less, and the B content is set to 0.0100% or less. The Ni content and Cr content are preferably 0.50% or less, the Mo. content is preferably 0.20% or less, and the B content is preferably 0.0030% or less.

### [Ca: 0% or More and 0.0100% or Less]

### [Mg: 0% or More and 0.0100% or Less]

### [REM: 0% or More and 0.0500% or Less]

### [Bi: 0% or More and 0.050% or Less]

Ca, Mg, and REM are elements having an action of improving the strength and bendability by adjusting shapes of inclusions. In addition, Bi is an element having an action of improving the strength and bendability by refining a solidification structure. Therefore, these elements may be contained. In order to sufficiently obtain the above effects, it is preferable that a Ca content and a Mg content are each set to 0.0001% or more, and a REM content and a Bi content are each set to 0.005% or more. More preferably, the Ca content and the Mg content are each 0.0008% or more, and the REM content and the Bi content are each 0.007% or more. It is not essential to obtain the above effects. Therefore, it is not necessary to particularly limit lower limits of the Ca content, the Mg content, the REM content, and Bi content, and the lower limits thereof are 0%.

On the other hand, even if these elements are excessively contained, the effect of the above-described action is saturated, which is uneconomical. Therefore, even in a case where these elements are contained, the Ca content is set to 0.0100% or less, the Mg content is set to 0.0100% or less, the REM content is set to 0.0500% or less, and the Bi content is set to 0.050% or less. Preferably, the Ca content is 0.0020% or less, the Mg content is 0.0020% or less, the REM content is 0.0020% or less, and the Bi content is 0.010% or less. REM means rare earth elements and is a generic term for a total of 17 elements of Sc, Y and lanthanides, and the REM content is a total amount of these elements.

The chemical composition of the steel sheet according to the present embodiment may be measured by a general method. For example, the chemical composition may be measured using inductively coupled plasma-atomic emission spectrometry (ICP-AES) for chips according to JIS G 1201 (2014). In this case, the chemical composition is an average content in an entire sheet thickness. C and S, which cannot be measured by ICP-AES, may be measured using a combustion-infrared absorption method, and N may be measured using an inert gas fusion-thermal conductivity method.

In a case where the steel sheet is provided with a coating such as a plating on a surface thereof, the chemical composition may be analyzed after removing the coating by mechanical grinding or the like. In a case where the coating is a plating layer, the coating may be removed by dissolving the plating layer in an acid solution containing an inhibitor that suppresses the corrosion of the steel sheet.

### Metallographic Structure (Microstructure)

First, the metallographic structure of the steel sheet according to the present embodiment will be described.

In the description of the metallographic structure of the steel sheet according to the present embodiment, microstructural fractions are indicated by volume percentages. Therefore, unless otherwise specified, “%” indicates “volume %”. In the present embodiment, a surface serving as a reference of a ¼ depth position means a surface of a base steel sheet excluding a plating layer (hot-dip galvanized layer or hot-dip galvannealed layer) in a case of a plated steel sheet.

A metallographic structure (microstructure) at a ¼ depth position (a ¼ thickness position from the surface) of the steel sheet (including the cold-rolled steel sheet, the hot-dip galvanized steel sheet, and the hot-dip galvannealed steel sheet) according to the present embodiment includes retained austenite: more than 1.0% and less than 10.0%, tempered martensite: 80.0% or more, ferrite and bainite: 0% or more and 15.0% or less in total, and martensite: 0% or more 3.0% or less.

### [Retained Austenite: More Than 1.0% and Less Than 10.0%]

Retained austenite improves ductility by a TRIP effect and contributes to an improvement in uniform elongation. Therefore, a volume percentage of retained austenite is set to more than 1.0%. The volume percentage of retained austenite is preferably more than 1.5%, and more preferably more than 2.0%.

On the other hand, when the volume percentage of retained austenite becomes excessive, a grain size of retained austenite increases. Such retained austenite having a large grain size becomes coarse and hard martensite after deformation. In this case, the origin of cracks is likely to occur, and the bendability deteriorates. Therefore, the volume percentage of retained austenite is set to less than 10.0%. The volume percentage of retained austenite is preferably less than 8.0%, and more preferably less than 7.0%.

### Tempered Martensite: 80.0% or More

Tempered martensite is an aggregate of lath-shaped grains similar to martensite (so-called fresh martensite). On the other hand, unlike martensite, tempered martensite is a hard structure containing fine iron-based carbides inside by tempering. Tempered martensite is obtained by tempering martensite generated by cooling or the like after annealing by a heat treatment or the like.

Tempered martensite is a structure that is not brittle and has ductility compared to martensite. In the cold-rolled steel sheet according to the present embodiment, a volume percentage of tempered martensite is set to 80.0% or more in order to improve the strength, bendability, and hydrogen embrittlement resistance. Preferably, the volume percentage of tempered martensite is 85.0% or more. The volume percentage of tempered martensite is less than 99.0%.

### [Ferrite and Bainite: 0% or More and 15.0% or Less in Total]

Ferrite is a soft phase generated by performing intercritical annealing or performing slow cooling after holding in the annealing step. In a case where ferrite is mixed with a hard phase such as martensite, the ductility of the steel sheet is improved. However, in order to achieve a strength as high as 1,310 MPa or more, it is necessary to limit the volume percentage of ferrite.

In addition, bainite is a phase generated by holding at 350° C. or higher and 450° C. or lower for a certain period of time in a process of cooling after holding at an annealing temperature. Bainite is softer than martensite and has an effect of improving the ductility. However, in order to achieve a strength as high as 1,310 MPa or more, it is necessary to limit a volume percentage of bainite as in the case of ferrite described above.

Therefore, the volume percentages of ferrite and bainite are set to 15.0% or less in total. The volume percentages of ferrite and bainite are preferably 10.0% or less. Since ferrite and bainite do not have to be included, lower limits thereof are each 0%. In addition, the volume percentages of ferrite and bainite are not limited.

### [Martensite: 0% or More and 3.0% or Less]

Martensite (fresh martensite) is an aggregate of lath-shaped grains that are generated by transformation from austenite during final cooling. Since martensite is hard and brittle and tends to be an origin of cracking during deformation, a large volume percentage of martensite causes the deterioration in the bendability. Therefore, the volume percentage of martensite is set to 3.0% or less. The volume percentage of martensite is preferably 2.0% or less, and more preferably 1.0% or less: Since martensite does not have to be included, a lower limit thereof is 0%.

### [Remainder in Microstructure]

The metallographic structure at the ¼ depth position may include, in addition to the above-described phases, pearlite as a remainder in the microstructure. However, pearlite is a structure having cementite in the structure and consumes C (carbon) in steel that contributes to an improvement in strength. Therefore, when the volume percentage of pearlite exceeds 5.0%, the strength of the steel sheet decreases. Therefore, the volume percentage of pearlite is set to 5.0% or less. The volume percentage of pearlite is preferably 3.0% or less, and more preferably 1.0% or less.

The volume percentage of each phase in the metallographic structure at the ¼ depth position of the steel sheet according to the present embodiment is measured as follows.

That is, the volume percentages of ferrite, bainite, martensite, tempered martensite, and pearlite are obtained by collecting a test piece from a random position in a rolling direction and in a width direction of the steel sheet, polishing a longitudinal section parallel to the rolling direction (cross section parallel to a sheet thickness direction), and observing a microstructure revealed by Nital etching at the ¼ depth position (a range of ⅛ to ⅜ of the sheet thickness from the surface is allowed) using a scanning electron microscope (SEM). In the SEM observation, five visual fields of 30 μm×50 μm are observed at a magnification of 3,000-fold, area ratios of each phase are measured from the observed images, and an average value thereof is calculated. In the steel sheet according to the present embodiment, since an area ratio of the longitudinal section parallel to the rolling direction can be regarded as being equal to a volume percentage, the area ratios obtained by the structural observation are each used as volume percentages.

In the measurement of the area ratio of each phase (structure), a region with no substructure revealed and a low luminance is defined as ferrite. In addition, a region with no substructure revealed and a high luminance is defined as martensite or retained austenite. In addition, a region in which a substructure is revealed is defined as tempered martensite or bainite.

Bainite and tempered martensite can be distinguished from each other by further carefully observing carbides in grains.

Specifically, tempered martensite includes martensite laths and cementite generated within the laths. Here, since there are two or more kinds of crystal orientation relationships between martensite laths and cementite, cementite included in the tempered martensite has a plurality of variants.

Bainite is classified into upper bainite and lower bainite. Upper bainite includes lath-shaped bainitic ferrite and cementite generated at the interface between the laths and can be easily distinguished from tempered martensite. Lower bainite includes lath-shaped bainitic ferrite and cementite generated within the laths. Here, there is one kind of crystal orientation relationship between bainitic ferrite and cementite unlike tempered martensite, and cementite included in lower bainite has the same variant. Therefore, lower bainite and tempered martensite can be distinguished from each other on the basis of the variants of cementite.

On the other hand, martensite and retained austenite cannot be clearly distinguished from each other by the SEM observation. Therefore, the volume percentage of martensite is calculated by subtracting the volume percentage of retained austenite calculated by a method described later from a volume percentage of a structure determined to be martensite or retained austenite.

The volume percentage of retained austenite is obtained as described below: a test piece is collected from a random position in the steel sheet, a rolled surface is chemically polished from the surface of the steel sheet to a ¼ thickness position (¼ depth position), and the volume percentage of retained austenite is quantified from integrated intensities of (200) and (210) planes of ferrite and integrated intensities of (200), (220), and (311) planes of austenite by MoKα radiation.

[Average Grain Size of Grains Firstly Counted in Sheet Thickness Direction from Surface When Viewed At Cross Section Parallel to Sheet Thickness Direction Is 20.0 μm or Less, and Average Grain Size of The Grains When Surface Is Viewed in Plan View Is 30.0 μm or Less]

The bendability is affected by the occurrence of cracks in an outermost layer of the steel sheet. Therefore, when a surface layer has a fine uniform structure, the bendability is improved.

As a result of further examinations by the present inventors, it was found that, in particular, the bendability is improved by allowing grains firstly counted in the sheet thickness direction from the surface, that is, grains in the outermost layer to be fine.

Therefore, an average grain size of the grains in the outermost layer when viewed at a cross section parallel to the sheet thickness direction is set to 20.0 μm or less, and an average grain size of the grains when the surface is viewed in a plan view is set to 30.0 μm or less.

The grains in the outermost layer are not limited to any specific phase, but are often ferrite (including bainitic ferrite) due to an influence of decarburization or the like.

In order to refine the grains in the outermost layer, it is effective to promote austenitic transformation while suppressing decarburization of the surface layer area by a manufacturing method described later, to form an internal oxide of Si, and utilize a pinning effect of the internal oxide.

Here, the surface means a surface of a cold-rolled steel sheet having no plating layer, and in a case of a hot-dip galvanized steel sheet or a hot-dip galvannealed steel sheet, means a surface of a base steel sheet excluding a plating layer (also referred to as an interface between the base steel sheet and the plating layer).

In the related art, there has been a case where a grain size at a position of several tens of um from a surface layer is controlled as a surface layer area. However, as a result of examinations by the present inventors, it was found that even if grains close to the surface layer (not the outermost layer) are fine, there are cases where only grains in the outermost layer become coarse and the bendability and hydrogen embrittlement resistance decrease, so that controlling grain sizes at positions close to the surface layer is not sufficient. Therefore, in the steel sheet according to the present embodiment, the grain sizes of the grains in the outermost layer are specified.

In addition, although there are cases where both the average grain size of the grains in the outermost layer when viewed at the cross section parallel to the sheet thickness direction and the average grain size of the grains when the surface is viewed in a plan view become coarse, there are cases where one becomes significantly coarse while the other does not become so coarse. Therefore, it is necessary to. simultaneously satisfy both the average grain size when viewed at the cross section parallel to the sheet thickness direction and the average grain size when the surface is viewed in a plan view.

The average grain size of the grains in the outermost layer when viewed at the cross section parallel to the sheet thickness direction and the average grain size when the surface is viewed in a plan view are obtained by the following method.

For the average grain size viewed at the cross section parallel to the sheet thickness direction, a cross section (longitudinal section) parallel to the rolling direction and parallel to the sheet thickness direction is cut out and polished, and a range of 100 μm in a thickness direction from the surface and 1,000 μm in a longitudinal direction is measured in three or more visual fields by electron back scattering diffraction (EBSD). Orientation analysis is performed using TSL OIM Analysis, which is a software attached to EBSD, and an orientation difference of 5° or more from adjacent measurement points is defined as a grain boundary, and an average size of the grains in the outermost layer is obtained.

For the grain size when the surface is viewed in a plan view, a range of 500 μm in the longitudinal direction and 500 μm in the width direction is measured in one or more visual fields by EBSD, and an average size of the grains is obtained in the same method as described above using TSL OIM Analysis.

In a case where a measurement target is the plated steel sheet, the above measurement is performed after the plating layer is peeled off with hydrochloric acid or the like.

### Mechanical Properties

### [Tensile Strength Is 1,310 MPa or More]

### [Uniform Elongation Is 4.0% or More]

### [R/t, Which Is Ratio of Limit Bend R to Sheet Thickness at 90° V-Bending, Is 5.0 or Less]

In the steel sheet according to the present embodiment, as the strength that contributes to a weight reduction of vehicle bodies of vehicles, a tensile strength (TS) is targeted to be 1,310 MPa or more. From the viewpoint of an impact absorption property, the strength of the steel sheet is preferably 1,400 MPa or more, and more preferably 1,470 MPa or more.

In addition, from the viewpoint of formability, a uniform elongation (uEl) is targeted to be 4.0% or more. In order to improve the formability, the uniform elongation (uEl) is preferably 4.5% or more, and more preferably 5.0% or more.

In addition, from the viewpoint of the formability, a ratio (R/t) of a limit bend R to a sheet thickness t at 90° V-bending is targeted to be 5.0 or less. In order to further improve the formability, (R/t) is preferably 4.0 or less, and more preferably 3.0 or less.

The tensile strength (TS) and the uniform elongation (uEl) are obtained by collecting a JIS No. 5 tensile test piece from the steel sheet in a direction perpendicular to the rolling direction and performing a tensile test according to JIS Z 2241:2011.

In addition, (R/t) is obtained by obtaining a minimum bend radius R, at which no cracking occurs when a 90° V-bending die is used while changing a radius R at a pitch of 0.5 mm, and dividing the minimum bend radius R by the sheet thickness t.

### Sheet Thickness

The sheet thickness of the steel sheet according to the present embodiment is not limited, but is preferably 0.8 to 2.6 mm in consideration of a product to which the steel sheet is supposed to be applied.

The steel sheet according to the present embodiment may have a hot-dip galvanized layer on the surface. Corrosion resistance is improved by providing a plating layer on the surface. When there is a concern about holes due to corrosion in a steel sheet for a vehicle, there are cases where the steel sheet cannot be thinned to a certain sheet thickness or less even if the high-strengthening is achieved. One of the purposes of the high-strengthening of the steel sheet is to reduce the weight by thinning. Therefore, even if a high strength steel sheet is developed, an application range of a steel sheet with low corrosion resistance is limited. As a method for solving these problems, it is conceivable to apply plating such as hot-dip galvanizing having high corrosion resistance to the steel sheet. In the steel sheet according to the present embodiment, since the composition of the steel sheet is controlled as described above, hot-dip galvanizing is possible.

The hot-dip galvanized layer may also be a hot-dip galvannealed layer.

### Manufacturing Method

The steel sheet according to the present embodiment can be manufactured by a manufacturing method including the following steps (I) to (VII):
(I) a hot rolling step of heating a cast slab having a predetermined chemical composition and performing hot rolling on the cast slab under conditions in which a rolling temperature FT is 960° C. or lower and a rolling reduction ratio is 18% or more in a final stand to obtain a hot-rolled steel sheet;
(II) a coiling step of coiling the hot-rolled steel sheet at a temperature of [Si]×200+500° C. or lower;
(III) a cold rolling step of descaling the hot-rolled steel sheet after the coiling step and performing cold rolling on the hot-rolled steel sheet at a cumulative rolling reduction ratio of 60% or less to obtain a cold-rolled steel sheet;
(IV) a bending-bending-back step of heating the cold-rolled steel sheet in a temperature range of 650° C. or higher and 800° C. or lower so that an average heating rate up to 650° C. is 3.0° C./sec or faster, and performing bending-bending-back deformation with a bending angle of 90 degrees or more one or more times using a roll having a radius of 850 mm or less while applying a tension of 3.0 kN or more in the temperature range;
(V) an annealing step of heating the cold-rolled steel sheet after the bending-bending-back step to an annealing temperature of 820° C. or higher in a nitrogen-hydrogen mixed atmosphere having a dew point of −20° C. or higher and 20° C. or lower and containing 1.0 volume % or more and 20 volume % or less of hydrogen, and performing soaking at the annealing temperature;
(VI) a post-annealing cooling step of cooling the cold-rolled steel sheet after the annealing step to a temperature of 50° C. or higher and 250° C. or lower so that average cooling rates in a temperature range of 700° C. to 600° C. and in a temperature range of 450° C. to 350° C. are 5° C./sec or faster; and
(VII) a tempering step of tempering the cold-rolled steel sheet after the post-annealing cooling step at a temperature of 200° C. or higher and 350° C. or lower for 1 second or longer.

In the manufacturing method of the steel sheet according to the present embodiment, in order to control not only the metallographic structure but also the average grain size of the grains firstly counted in the sheet thickness direction from the surface, which has not received attention in the related art, each step needs to satisfy the above-described conditions simultaneously. For example, as will be described later, in a case where grains are refined in the hot rolling step, carbides are finely dispersed in the coiling step, and cold rolling is performed at a cumulative rolling reduction ratio of 60% or less, decarburization in the surface layer area is sufficiently suppressed in the annealing step. Furthermore, since the internal oxide of Si is formed in the surface layer area by the annealing step after the decarburization is suppressed as described above, coarsening of grains in the outermost layer is suppressed by the pinning effect of the internal oxide. That is, each step affects the conditions of the other steps, and thus it is important to set the conditions throughout the steps.

Hereinafter, each step will be described.

### [Hot Rolling Step]

In the hot rolling step, the cast slab having the same chemical composition as the steel sheet according to the present embodiment described above is heated and hot-rolled to obtain the hot-rolled steel sheet. In a case where a temperature of the cast slab is high, the cast slab may be subjected to the hot rolling as it is without being cooled to around room temperature. Slab heating conditions in the hot rolling are not limited, but the cast slab is preferably heated to 1,100° C. or higher. When a heating temperature is lower than 1,100° C., homogenization of materials may become insufficient. An upper limit of the heating temperature is not limited, but may be 1,350° C. or lower from the viewpoint of economic rationality.

The rolling temperature (FT) in the finish final stand during the hot rolling is set to 960° C. or lower, and the rolling reduction ratio in the final stand is set to 18% or more. By setting the rolling reduction ratio and the rolling reduction ratio in the final stand as described above, grains can be refined, and carbides can be finely dispersed in the coiling step, which is the subsequent step. With such a structure, decarburization in the surface layer area is suppressed in the subsequent annealing step.

When the rolling temperature (FT) in the final stand is higher than 960° C. or the rolling reduction ratio in the final stand is less than 18%, a sufficient effect cannot be obtained. As the rolling temperature decreases, a rolling load increases. Therefore, the rolling temperature in the final stand is preferably 800° C. or higher. As the rolling reduction ratio increases, the rolling load increases. Therefore, the rolling reduction ratio in the final stand is preferably 30% or less.

Since the chemical composition does not substantially change during a manufacturing process, the chemical composition of the cast slab may be the same as the chemical composition of the target cold-rolled steel sheet. A manufacturing method of the cast slab is not limited. The cast slab is preferably cast by a continuous casting method from the viewpoint of productivity, but may also be manufactured by an ingot-making method or a thin slab casting method.

In a case where a steel piece obtained by continuous casting can be subjected to the hot rolling step while a sufficiently high temperature is maintained, the heating step may be omitted.

### [Coiling Step]

In the coiling step, when a coiling temperature of the steel sheet (hot-rolled steel sheet) after the hot rolling step is denoted by CT and the Si content by mass % of the steel sheet is denoted by [Si], coiling is performed at a coiling temperature CT at which CT≤[Si]×200+500 (C) is satisfied. After the hot rolling ends, cooling conditions up to the coiling temperature are not particularly limited.

Generally, it is considered that when the coiling temperature is lowered, the strength of the hot-rolled steel sheet increases, and manufacturability decreases. However, in the manufacturing method of the steel sheet according to the present embodiment, the coiling temperature is lowered. Specifically, the coiling temperature is set to [Si]×200+500 (° C.) or lower. Accordingly, the generation of a Si-deficient layer can be suppressed. When the Si-deficient layer is generated, the internal oxide of Si cannot be formed, and the pinning effect of the internal oxide is not obtained, resulting in coarsening of the grains in the outermost layer. Therefore, in order to suppress the grains in the outermost layer, it is effective to suppress the generation of a Si-deficient layer.

In addition, by setting the coiling temperature as described above, carbides can be precipitated in a uniformly and finely dispersed state.

When the coiling temperature is higher than [Si]×200+500 (C), the above effect cannot be sufficiently obtained.

### [Cold Rolling Step]

In the cold rolling step, the steel sheet (hot-rolled steel sheet) after the coiling step is descaled by pickling or the like by a known method as necessary, and then cold-rolled with a rolling reduction ratio (cumulative rolling reduction) of 60% or less to obtain the cold-rolled steel sheet.

When the rolling reduction ratio in the cold rolling is high, recrystallization during annealing is promoted, and y transformation in the annealing step is less likely to occur in the surface layer area. In this case, grains in the surface layer area become coarse due to annealing. Therefore, the rolling reduction ratio of the cold rolling is set to 60% or less.

After the descaling and before the cold rolling, the surface of the steel sheet may be further ground by about 0.1 μm to 5.0 μm with a brush or the like. By performing the grinding, an effect of further refining the grains in the outermost layer due to graining strain can be obtained.

The cold-rolled steel sheet after the cold rolling step may be subjected to a treatment such as degreasing according to a known method as necessary.

### [Bending-Bending-Back Step]

In the bending-bending-back step, the steel sheet (cold-rolled steel sheet) after the cold rolling step is heated in a temperature range of 650° C. or higher and 800° C. or lower so that an average heating rate up to 650° C. is 3.0° C./sec or faster, and is subjected to bending-bending-back deformation with a bending angle of 90 degrees or more one or more times using a roll having a radius of 850 mm or less while applying a tension of 3.0 kN or more in the temperature range.

For example, bending is performed with a bending angle of 90 degrees or more using the roll having a radius of 850 mm or less so that the surface is on an inside, and thereafter bending is performed with a bending angle of 90 degrees or more so that a rear surface is on the inside, whereby predetermined bending-bending-back can be achieved. By this bending-bending-back, strain is applied to the surface layer during annealing heating, austenitic transformation is promoted, and decarburization is suppressed, whereby the formation of a ferrite single phase, in which coarsening is likely to occur, in the surface layer can be suppressed. As a result, the grains in the surface layer and the surface are refined, and high bendability and hydrogen embrittlement resistance can be obtained.

In a case where the radius of the roll used for the bending is large (the bend radius is large) or the bending angle is small, the strain introduced into the surface layer becomes insufficient, the grains in the surface layer and the surface become coarse, and high bendability and hydrogen embrittlement resistance cannot be obtained.

In addition, when a temperature at which the bending-bending-back is performed is lower than 650° C., a yield strength of the steel is high, and plastic deformation does not occur since the deformation becomes elastic deformation. Therefore, the above effect cannot be sufficiently obtained. On the other hand, at a temperature higher than 800° C., ferrite becomes coarser before performing the bending-bending-back, so that the refining effect cannot be obtained.

When the average heating rate up to 650° C. is slow, recrystallization proceeds, and it is difficult for γ transformation of the surface layer to occur during annealing, which causes coarsening of the surface layer. Therefore, the average heating rate up to 650° C. is set to 3.0° C./sec or faster. The average heating rate is preferably 5.0° C./sec or faster, and more preferably 7.0° C./sec or faster.

The tension at the bending-bending-back is preferably 6.0 kN or more, and preferably 8.0 kN or more in order to reliably apply strain to the surface layer.

### [Annealing Step]

In the annealing step, the steel sheet (cold-rolled steel sheet) after the bending-bending-back step is heated to an annealing temperature of 820° C. or higher in a nitrogen-hydrogen mixed atmosphere having a dew point of −20° C. or higher and 20° C. or lower and containing 1.0 volume % or more and 20.0 volume % or less of hydrogen, as it is without being cooled once, and then soaked at the annealing temperature (soaking temperature).

By setting the atmosphere during heating in the annealing as described above, fine internal oxides can be formed, and the grains in the surface layer area can be refined. An atmosphere during the soaking is not limited, but may be the same as that during the heating,

When the soaking temperature is low, austenite single-phase annealing is not achieved, the volume percentage of ferrite increases, and the bendability deteriorates, Therefore, the soaking temperature is set to 820° C. or higher. The soaking temperature is preferably 830° C. or higher. The bendability can be easily secured with a high soaking temperature. However, when the soaking temperature is too high, a manufacturing cost increases. Therefore, the soaking temperature is preferably 900° C. or lower. The soaking temperature is more preferably 880° C. or lower, and even more preferably 870° C. or lower.

A soaking time is preferably 30 to 450 seconds. When the soaking time is shorter than 30 seconds, there are cases where austenitizing does not sufficiently progress. Therefore, the soaking time is preferably 30 seconds or longer. On the other hand, when the soaking time exceeds 450 seconds, the productivity decreases. Therefore, the soaking time is preferably 450 seconds or shorter.

### [Post-Annealing Cooling Step]

In the post-annealing cooling step, in order to obtain the above-described metallographic structure, the cold-rolled steel sheet after the annealing step is cooled to a temperature of 50° C. or higher and 250° C. or lower so that both average cooling rates in a ferritic transformation temperature range of 700° C. to 600° C. and in a bainitic transformation temperature range of 450° C. to 350° C. are 5° C./sec or faster.

When the cooling rates in the above temperature ranges are slow, the volume percentages of ferrite and bainite at the ¼ depth position increase, and the volume percentage of tempered martensite decreases. As a result, the tensile strength decreases, and the bendability and hydrogen embrittlement resistance deteriorate. Therefore, both the average cooling rates from 700° C. to 600° C. and from 450° C. to 350° C. are set to 5° C./sec or faster. The average cooling rates are preferably 10° C./sec or faster, and more preferably 20° C./sec or faster.

A cooling stop temperature and a holding temperature are set to 50° C. or higher and 250° C. or lower. When the cooling stop temperature is high, (untempered) martensite increases in the cooling after the subsequent tempering step, and the bendability and hydrogen embrittlement resistance deteriorate. Therefore, the cooling stop temperature is set to 250° C. or lower. The cooling stop temperature is preferably 220° C. or lower, and more preferably 200° C. or lower.

On the other hand, when the cooling stop temperature is low, a retained austenite fraction decreases, and a target uniform elongation is not obtained. Therefore, the cooling stop temperature is set to 50° C. or higher. The cooling stop temperature is preferably 75° C. or higher, and more preferably 100° C. or higher.

### [Hot-Dip Galvanizing]

### [Alloying]

In a case of manufacturing a cold-rolled steel sheet (hot-dip galvanized steel sheet) provided with a hot-dip galvanized layer on a surface, in the post-annealing cooling step, in a state where the temperature of the steel sheet is higher than 425° C. and lower than 600° C., the cold-rolled steel sheet may be further subjected to hot-dip galvanizing by being immersed in a plating bath at the similar temperature. A composition of the plating bath may be in a known range. In addition, in a case of manufacturing a cold-rolled steel sheet (hot-dip galvannealed steel sheet) subjected to hot-dip galvannealing on a surface, an alloying heat treatment of heating the cold-rolled steel sheet at, for example, higher than 450° C. and lower than 600° C. may be performed subsequent to the above-described hot-dip galvanizing step to form hot-dip galvannealing as a plating.

### [Tempering Step]

In the cold-rolled steel sheet after the post-annealing cooling step, by cooling to a temperature of 50° C. or higher and 250° C. or lower, untransformed austenite is transformed into martensite.

In the tempering step, the cold-rolled steel sheet is tempered at a temperature of 200° C. or higher and 350° C. or lower for 1 second or longer, whereby a structure primarily containing tempered martensite at the 1/4 depth position is obtained.

In a case where the hot-dip galvanizing step and/or the alloying step is performed, the cold-rolled steel sheet after the hot-dip galvanizing step or the cold-rolled steel sheet after the hot-dip galvanizing step and the alloying step is cooled to a temperature of 50° C. or higher and 250° C. or lower, and then tempered at a temperature of 200° C. or higher and 350° C. or lower for 1 second or longer. When a tempering temperature is higher than 350° C., the strength of the steel sheet decreases, Therefore, the tempering temperature is set to 350° C. or lower. The tempering temperature is preferably 325° C. or lower, and more preferably 300° C. or lower.

On the other hand, when the tempering temperature is lower than 200° C., the tempering becomes insufficient, and the bendability and hydrogen embrittlement resistance deteriorate. Therefore, the tempering temperature is set to 200° C. or higher. The tempering temperature is preferably 220° C. or higher, and more preferably 250° C. or higher.

A tempering time may be 1 second or longer, but is preferably 5 seconds or longer, and more preferably 10 seconds or longer in order to perform a stable tempering treatment. On the other hand, since there are cases where long tempering decreases the strength of the steel sheet, the tempering time is preferably 750 seconds or shorter, and more preferably 500 seconds or shorter.

### [Skin Pass Step]

The cold-rolled steel sheet after the tempering step may be cooled to a temperature at which skin pass rolling is possible and then subjected to skin pass rolling. In a case where the cooling after the annealing is water spray cooling, dip cooling, air-water cooling, or the like in which water is used, it is preferable to perform pickling and, subsequently, plating of a small amount of one or two or more of Ni, Fe, Co, Sn, and Cu before the skin pass rolling in order to remove an oxide film formed by contact with water at a high temperature and improve chemical convertibility of the steel sheet. Here, the small amount refers to a plating amount of about 3 to 30 mg/m² on the surface of the steel sheet.

A shape of the steel sheet can be adjusted by the skin pass rolling. An elongation ratio of the skin pass rolling is preferably 0.05% or more. The elongation ratio of the skin pass rolling is more preferably 0.10% or more. On the other hand, when the elongation ratio of the skin pass rolling is high, the volume percentage of retained austenite decreases, and the ductility deteriorates. Therefore, the elongation ratio is preferably set to 1.00% or less. The elongation ratio is more preferably 0.75% or less, and even more preferably 0.50% or less.

### Examples

The present invention will be described more specifically with reference to examples.

Slabs having the chemical composition shown in Table I were cast.

The slab after the casting was heated to 1,100° C. or higher, hot-rolled to 2.8 mm, coiled, and then cooled to room temperature. Hot rolling conditions and the coiling temperatures were as shown in Tables 2A and 2B.

Thereafter, scale was removed by pickling, cold rolling to 1.4 mm was performed, heating in a temperature range of 650° C. or higher and 800° C. or lower was then performed so that the average heating rate up to 650° C. was the rate shown in Tables 2A and 2B, and bending-bending-back was performed in which bending was performed with a bending angle of 90 degrees or more so that a surface was on an inside and thereafter bending was performed with a bending angle of 90 degrees or more so that a rear surface was on the inside, along a roll having the radius shown in Tables 2A and 2B.

Subsequently (without cooling), heating to the annealing temperature of Tables 2A and 2B was performed in a nitrogen-hydrogen mixed atmosphere having a dew point of −20° C. or higher and 20° C. or lower and containing 1.0 vol % or more and 20.0 vol % or less of hydrogen, and annealing was performed at the annealing temperature for 120 seconds.

After the annealing, cooling to a cooling stop temperature of 50° C. or higher and 250° C. or lower was performed so that average cooling rates in a temperature range of 700° C. to 600° C. and in a temperature range of 450° C. to 350° C. were 20° C./sec or faster, and thereafter a tempering heat treatment was performed at 200° C. to 350° C. for 1 second to 500 seconds.

In some of the examples, hot-dip galvanizing and alloying were performed during post-annealing cooling. Regarding the presence or absence of plating shown in Tables 3A and 3B, “CR” indicates a cold-rolled steel sheet that has not been galvanized, “GI” is a hot-dip galvanized steel sheet, and “GA” is a hot-dip galvannealed steel sheet. The hot-dip galvannealed steel sheet was obtained by performing hot-dip galvanizing of about 35 to 65 g/m² at a temperature of higher than 450° C. and lower than 600° C. and then further performing alloying at a temperature of higher than 450° C. and lower than 600°.

TABLE 1

| | Chemical composition (mass %) | | | | | | | |
|---|---|---|---|---|---|---|---|---|
| | (remainder: Fe and impurities) | | | | | | | |
| Steel | C | Si | Mn | P | S | Al | N | Others |
| A | 0.135 | 0.41 | 2.22 | 0.010 | 0.001 | 0.029 | 0.0031 | |
| B | 0.223 | 0.05 | 2.47 | 0.009 | 0.001 | 0.032 | 0.0037 | |
| C | 0.236 | 0.87 | 1.97 | 0.010 | 0.001 | 0.034 | 0.0032 | |
| D | 0.403 | 0.41 | 3.42 | 0.009 | 0.001 | 0:033 | 0.0028 | |
| E | 0.224 | 1.05 | 2.34 | 0.009 | 0.001 | 0.034 | 0.0032 | |
| F | 0.320 | 0.82 | 3.55 | 0.008 | 0.001 | 0.028 | 0.0027 | |
| G | 0.224 | 0.52 | 2.22 | 0.010 | 0.001 | 0.118 | 0.0032 | |
| H | 0.241 | 0.54 | 2.84 | 0.009 | 0.001 | 0.035 | 0.0031 | |
| I | 0.244 | 0.51 | 2.81 | 0.010 | 0.001 | 0.036 | 0.0032 | |
| J | 0.222 | 0.46 | 2.86 | 0.009 | 0.001 | 0.031 | 0.0033 | |
| K | 0.156 | 0.47 | 3.22 | 0.009 | 0.001 | 0.033 | 0.0035 | |
| L | 0.224 | 0.43 | 2.86 | 0.008 | 0.001 | 0.029 | 0.0030 | V: 0.09 |
| M | 0.243 | 0.45 | 2.87 | 0.009 | 0.001 | 0.040 | 0.0031 | Ti: 0:022 |
| | | | | | | | | Nb: 0:007 |
| | | | | | | | | B: 0.0016 |
| N | 0.375 | 0.46 | 2.21 | 0.009 | 0.001 | 0.032 | 0.0033 | Mo: 0.07 |
| | | | | | | | | Cr: 0:26 |
| O | 0.234 | 0.44 | 2.87 | 0.009 | 0.001 | 0.036 | 0.0029 | Bi: 0.009 |
| | | | | | | | | REM: 0.0008 |
| P | 0.233 | 0.42 | 2.88 | 0.008 | 0.001 | 0.027 | 0.0037 | Ca: 0.0080 |
| | | | | | | | | Mg: 0.0010 |

TABLE 2A

| | | Hot rolling step | | | | Bending-bending-back step | | | |
|---|---|---|---|---|---|---|---|---|---|
| | | | Final | | | Average | | | |
| | | | stand | | | heating | | | Annealing |
| | | Final stand | rolling | Coiling step | | rate up | | | step |
| | | rolling | reduction | Coiling | [Si] × | to | Line | Roll | Annealing |
| Test | | temperature | ratio | temperature | 200 + | 650° C. | tension | radius | temperature |
| No. | Steel | (° C.) | (%) | (° C.) | 500 | (° C./sec) | (kN) | (mm) | (° C.) |
| 1 | A | 950 | 20 | 520 | 582 | 8.5 | 9.4 | 600 | 825 |
| 2 | B | 940 | 17 | 545 | 510 | 8.5 | 9.8 | 600 | 850 |
| 3 | B | 940 | 19 | 500 | 510 | 8.5 | 9.8 | 600 | 825 |
| 4 | C | 940 | 20 | 525 | 674 | 8.5 | 9.7 | 600 | 830 |
| 5 | D | 930 | 19 | 510 | 582 | 8.5 | 9.4 | 600 | 825 |
| 6 | E | 920 | 20 | 520 | 710 | 8.5 | 9.0 | 600 | 820 |
| 7 | E | 935 | 20 | 510 | 710 | 8.5 | 9.3 | 600 | 850 |
| 8 | F | 920 | 20 | 525 | 664 | 8.5 | 9.4 | 600 | 820 |
| 9 | G | 935 | 18 | 525 | 604 | 8.5 | 10.1 | 600 | 825 |
| 10 | H | 930 | 19 | 520 | 608 | 8.5 | 10.2 | 600 | 845 |
| 11 | H | 980 | 19 | 590 | 608 | 8.5 | 9.8 | 600 | 850 |
| 12 | H | 920 | 16 | 560 | 608 | 8.5 | 9.8 | 600 | 845 |
| 13 | H | 920 | 18 | 615 | 608 | 8.5 | 10.0 | 600 | 845 |
| 14 | H | 935 | 19 | 525 | 608 | 8.5 | 10.1 | 600 | 810 |
| 15 | H | 930 | 19 | 510 | 608 | 8.5 | 2.5 | 600 | 830 |
| 16 | H | 920 | 20 | 510 | 608 | 8.5 | 10.2 | 900 | 825 |
| 17 | H | 940 | 19 | 520 | 608 | 8.5 | 10.1 | 600 | 855 |

TABLE 2B

| | | Hot rolling step | | | | Bending-bending-back step | | | |
|---|---|---|---|---|---|---|---|---|---|
| | | | Final | | | Average | | | |
| | | | stand | | | heating | | | Annealing |
| | | Final stand | rolling | Coiling step | | rate up | | | step |
| | | rolling | reduction | Coiling | [Si] × | to | Line | Roll | Annealing |
| Test | | temperature | ratio | temperature | 200 + | 650° C. | tension | radius | temperature |
| No. | Steel | (° C.) | (%) | (° C.) | 500 | (° C./sec) | (kN) | (mm) | (° C.) |
| 18 | H | 930 | 20 | 525 | 608 | 8.5 | 9.6 | 600 | 820 |
| 19 | H | 930 | 19 | 520 | 608 | 8.5 | 9.8 | 600 | 825 |
| 20 | H | 935 | 20 | 525 | 608 | 8.5 | 10.4 | 600 | 825 |
| 21 | H | 935 | 20 | 520 | 608 | 8.5 | 9.6 | 600 | 845 |
| 22 | H | 940 | 19 | 525 | 608 | 8.5 | 10.1 | 600 | 845 |
| 23 | H | 930 | 20 | 510 | 608 | 8.5 | 9.2 | 600 | 850 |
| 24 | H | 920 | 20 | 520 | 608 | 8.5 | 10.1 | 600 | 845 |
| 25 | H | 930 | 19 | 525 | 608 | 8.5 | 10.1 | 600 | 820 |
| 26 | 1 | 940 | 20 | 510 | 602 | 8.5 | 9.4 | 600 | 845 |
| 27 | J | 930 | 19 | 510 | 592 | 8.5 | 10.3 | 600 | 845 |
| 28 | K | 920 | 20 | 520 | 594 | 8.5 | 10.2 | 600 | 840 |
| 29 | I | 940 | 20 | 525 | 586 | 8.5 | 10.4 | 600 | 835 |
| 30 | M | 930 | 20 | 510 | 590 | 8.5 | 10.1 | 600 | 840 |
| 31 | M | 940 | 20 | 525 | 590 | 8.5 | 9.6 | 600 | 845 |
| 32 | N | 930 | 19 | 510 | 592 | 8.5 | 10.1 | 600 | 825 |
| 33 | O | 920 | 19 | 510 | 588 | 8.5 | 10.2 | 600 | 820 |
| 34 | O | 935 | 20 | 510 | 588 | 8.5 | 9.8 | 600 | 855 |
| 35 | P | 930 | 19 | 525 | 584 | 8.5 | 10.3 | 600 | 850 |

A test piece for SEM observation was collected from the obtained cold-rolled steel sheet as described above, a longitudinal section parallel to a rolling direction was polished, a metallographic structure at a ¼ depth position was then observed, and a volume percentage of each structure was measured by image processing. In addition, a test piece for X-ray diffraction was collected, and from the section chemically polished to the ¼ depth position from a surface layer as described above, the volume percentage of retained austenite was measured by X-ray diffraction. Accordingly, the volume percentages of ferrite, bainite, martensite, tempered martensite, pearlite, and retained austenite were obtained.

In addition, in the above-described method, an average grain size of grains in an outermost layer when viewed at a cross section (L-section) parallel to the rolling direction and a sheet thickness direction, and an average grain size of the grains when the surface was viewed in a plan view were obtained using EBSD and TSL OIM Analysis, which is an attached software.

The results are shown in Tables 3A and 3B.

TABLE 3A

| | Metallographic structure at ¼ depth position | | | | | | | | | |
|---|---|---|---|---|---|---|---|---|---|---|
| | Metallographic structure volume percentage | | | | | | | | | |
| | | | Ferrite | | | | | | | |
| | | | and | | | | | Outermost | | |
| | | | bainite | | | | | grain size | | Presence |
| | | | in | Retained | | Tempered | | (μm) | | or absence |
| Test | Ferrite | Bainite | total | austenite | Martensite | martensite | Remainder | Plan | L- | of plating |
| No. | (%) | (%) | (%) | (%) | (%) | (%) | (%) | view | section | CR/GI/GA |
| 1 | 4.2 | 10.9 | 15.1 | 3.2 | 0.0 | 81.7 | 0.0 | 12.2 | 9.8 | CR |
| 2 | 0.0 | 3.1 | 3.1 | 0.9 | 0.0 | 96.0 | 0.0 | 45.3 | 21.3 | CR |
| 3 | 0.0 | 5.9 | 5.9 | 1.6 | 0.0 | 92.5 | 0.0 | 27.6 | 19.1 | CR |
| 4 | 3.1 | 25.2 | 28.3 | 5.2 | 0.0 | 66.5 | 0.0 | 8.6 | 6.8 | CR |
| 5 | 0.0 | 0.0 | 0.0 | 7.6 | 5.4 | 87.0 | 0.0 | 8.4 | 6.7 | CR |
| 6 | 15.4 | 35.4 | 50.8 | 10.3 | 6.4 | 32.5 | 0.0 | 8.2 | 6.5 | CR |
| 7 | 0.0 | 14.6 | 14.6 | 5.1 | 0.0 | 80.3 | 0.0 | 8.3 | 6.4 | CR |
| 8 | 0.0 | 0.0 | 0.0 | 6.1 | 5.2 | 88.7 | 0.0 | 8.5 | 6.9 | GA |
| 9 | 25.4 | 0.0 | 25.4 | 6.4 | 0.0 | 68.2 | 0.0 | 12.3 | 9.6 | CR |
| 10 | 0.0 | 9.8 | 9.8 | 5.0 | 0.0 | 85.2 | 0.0 | 12.5 | 9.8 | CR |
| 11 | 0.0 | 9.4 | 9.4 | 4.8 | 0.0 | 85.8 | 0.0 | 32.4 | 18.7 | GA |
| 12 | 0.0 | 9.5 | 9.5 | 4.9 | 0.0 | 85.6 | 0.0 | 33.2 | 18.5 | GA |
| 13 | 0.0 | 10.2 | 10.2 | 5.1 | 0.0 | 84.7 | 0.0 | 36.8 | 20.2 | GI |
| 14 | 18.6 | 5.4 | 24.0 | 6.0 | 1.4 | 68.6 | 0.0 | 12.4 | 9.7 | CR |
| 15 | 8.1 | 2.6 | 10.7 | 5.7 | 1.8 | 80.7 | 1.1 | 32.1 | 18.2 | GA |
| 16 | 9.5 | 2.6 | 12.1 | 5.8 | 1.6 | 80.5 | 0.0 | 31.9 | 17.9 | CR |
| 17 | 0.0 | 3.8 | 3.8 | 5.1 | 0.0 | 91.1 | 0.0 | 12.3 | 9.6 | CR |

TABLE 3B

| | Metallographic structure at ¼ depth position | | | | | | | | | |
|---|---|---|---|---|---|---|---|---|---|---|
| | Metallographic structure volume percentage | | | | | | | | | |
| | | | Ferrite | | | | | | | |
| | | | and | | | | | Outermost | | |
| | | | bainite | | | | | grain size | | Presence |
| | | | in | Retained | | Tempered | | (μm) | | or absence |
| Test | Ferrite | Bainite | total | austenite | Martensite | martensite | Remainder | Plan | L- | of plating |
| No. | (%) | (%) | (%) | (%) | (%) | (%) | (%) | view | section | CR/GI/GA |
| 18 | 10.2 | 0.0 | 10.2 | 5.2 | 0.0 | 83.4 | 1.2 | 12.4 | 9.7 | GA |
| 19 | 3.7 | 4.9 | 8.6 | 5.4 | 0.0 | 85.2 | 0.8 | 12.5 | 9.4 | CR |
| 20 | 3.6 | 10.0 | 13.6 | 5.3 | 0.0 | 81.1 | 0.0 | 12.8 | 9.8 | GA |
| 21 | 0.0 | 0.0 | 0.0 | 5.2 | 0.0 | 94.8 | 0.0 | 12.6 | 9.2 | GI |
| 22 | 0.0 | 11.3 | 11.3 | 5.8 | 0.0 | 82.9 | 0.0 | 13.0 | 9.7 | CR |
| 23 | 0.0 | 14.5 | 14.5 | 5.3 | 0.0 | 80.2 | 0.0 | 12.4 | 9.1 | GA |
| 24 | 0.0 | 10.7 | 10.7 | 5.4 | 0.0 | 83.9 | 0.0 | 12.0 | 9.1 | GI |
| 25 | 12.0 | 0.0 | 12.0 | 5.2 | 0.0 | 80.8 | 2.0 | 12.8 | 9.9 | CR |
| 26 | 0.0 | 9.4 | 9.4 | 5.4 | 0.0 | 85.2 | 0.0 | 12.4 | 9.3 | CR |
| 27 | 0.0 | 0.0 | 0.0 | 5.3 | 0.0 | 94.7 | 0.0 | 12.2 | 9.2 | GA |
| 28 | 0.0 | 9.7 | 9.7 | 5.6 | 0.0 | 84.7 | 0.0 | 12.5 | 9.5 | CR |
| 29 | 0.0 | 9.7 | 9.7 | 5.7 | 0.0 | 84.6 | 0.0 | 12.1 | 9.7 | CR |
| 30 | 0.0 | 10.0 | 10.0 | 5.5 | 0.0 | 84.5 | 0.0 | 12.3 | 9.6 | GA |
| 31 | 0.0 | 9.4 | 9.4 | 5.6 | 0.0 | 85.0 | 0.0 | 12.4 | 9.7 | CR |
| 32 | 8.6 | 0.0 | 8.6 | 7.5 | 2.6 | 80.5 | 0.8 | 12.1 | 9.0 | CR |
| 33 | 3.6 | 6.4 | 10.0 | 5.3 | 0.0 | 84.7 | 0.0 | 12.3 | 9.4 | GI |
| 34 | 0.0 | 8.4 | 8.4 | 5.4 | 0.0 | 86.2 | 0.0 | 12.2 | 9.1 | CR |
| 35 | 0.0 | 9.8 | 9.8 | 5.5 | 0.0 | 84.7 | 0.0 | 12.4 | 9.6 | GA |

In addition, tensile strength (TS), uniform elongation (uEl), (R/t), and hydrogen embrittlement resistance were evaluated as described below.

The tensile strength (TS) and the uniform elongation (uEl) were obtained by collecting a JIS No. 5 tensile test piece from the cold-rolled steel sheet in a direction perpendicular to the rolling direction, and conducting a tensile test according to JIS Z 2241:2011.

(R/t), which is an index of bendability, was obtained by obtaining a minimum bend radius R at which no cracking had occurred when a 90° V-bending die was used and a radius R was changed at a pitch of 0.5 mm, and dividing the minimum bend radius R by a sheet thickness (t=1.4 mm).

The following test was conducted to evaluate the hydrogen embrittlement resistance.

That is, a test piece having a mechanically ground end surface was bent into a U-shape by a press bending method to prepare a U-bending test piece with a smallest possible bend radius R, the U-bending test piece was tightened with bolts to be elastically deformed so that non-bent portions were parallel to each other, and thereafter a delayed fracture acceleration test in which hydrogen was allowed to penetrate into the steel sheet was conducted by immersing the U-bending test piece in hydrochloric acid having a pH of 1. Those in which cracking did not occur even when an immersion time was 100 hours were evaluated as steel sheets having a good (O: OK) delayed fracture resistance property, and those in which cracking had occurred were evaluated as defective (X: NG). In order to remove an influence of plating, regarding a plating material, a plating layer was removed with hydrochloric acid containing an inhibitor before the test, and thereafter the hydrogen embrittlement resistance was evaluated.

The results of mechanical properties of each are shown in Table 4.

TABLE 4

| | Mechanical properties | | | | |
|---|---|---|---|---|---|
| | | | Limit | | |
| | | Uniform | bend | Hydrogen | |
| Test | TS | elongation | radius | embrittlement | |
| No. | (MPa) | (%) | (R/t) | resistance | Note |
| 1 | 1298 | 5.1 | 4.6 | ◯ | Comparative Example |
| 2 | 1594 | 3.9 | 5.7 | X | Comparative Example |
| 3 | 1565 | 5.2 | 4.3 | ◯ | Invention Example |
| 4 | 1304 | 7.2 | 6.4 | ◯ | Comparative Example |
| 5 | 1981 | 6.7 | 6.8 | X | Comparative Example |
| 6 | 930 | 16.5 | 5.4 | ◯ | Comparative Example |
| 7 | 1421 | 6.7 | 5.4 | X | Comparative Example |
| 8 | 1632 | 6.3 | 6.8 | X | Comparative Example |
| 9 | 1298 | 8.1 | 4.3 | ◯ | Comparative Example |
| 10 | 1488 | 6.3 | 2.1 | ◯ | Invention Example |
| 11 | 1484 | 6.2 | 5.4 | X | Comparative Example |
| 12 | 1486 | 6.2 | 5.4 | X | Comparative Example |
| 13 | 1484 | 3.3 | 5.7 | X | Comparative Example |
| 14 | 1276 | 7.9 | 5.4 | ◯ | Comparative Example |
| 15 | 1436 | 8.1 | 5.4 | X | Comparative Example |
| 16 | 1442 | 7.6 | 5.4 | X | Comparative Example |
| 17 | 1560 | 6.1 | 2.1 | ◯ | Invention Example |
| 18 | 1456 | 6.2 | 2.5 | ◯ | Invention Example |
| 19 | 1488 | 6.3 | 2.1 | ◯ | Invention Example |
| 20 | 1403 | 6.0 | 2.5 | ◯ | Invention Example |
| 21 | 1596 | 5.8 | 2.1 | ◯ | Invention Example |
| 22 | 1456 | 6.9 | 2.5 | ◯ | Invention Example |
| 23 | 1417 | 6.7 | 2.5 | ◯ | Invention Example |
| 24 | 1459 | 6.8 | 2.1 | ◯ | Invention Example |
| 25 | 1420 | 6.9 | 2.5 | ◯ | Invention Example |
| 26 | 1483 | 6.7 | 2.1 | ◯ | Invention Example |
| 27 | 1567 | 6.2 | 1.8 | ◯ | Invention Example |
| 28 | 1360 | 7.1 | 2.1 | ◯ | Invention Example |
| 29 | 1480 | 6.8 | 2.1 | ◯ | Invention Example |
| 30 | 1481 | 6.3 | 2.1 | ◯ | Invention Example |
| 31 | 1482 | 6.4 | 2.1 | ◯ | Invention Example |
| 32 | 1842 | 6.4 | 4.3 | ◯ | Invention Example |
| 33 | 1476 | 6.5 | 2.1 | ◯ | Invention Example |
| 34 | 1490 | 6.4 | 2.1 | ◯ | Invention Example |
| 35 | 1473 | 6.6 | 2.1 | ◯ | Invention Example |

As can be seen from Tables 1 to 4, all of the steels of the present invention (Test Nos. 3, 10, and 17 to 35) had a TS of 1,310 MPa or more, a uEl of 4.0% or more, an (R/t) of 5.0 or less, and good hydrogen embrittlement resistance.

Contrary to this, in test numbers (comparative examples) in which any of the chemical composition and the manufacturing method was outside of the range of the present invention and the metallographic structure at the ¼ depth position and the average grain size of the grains in the outermost layer were outside of the ranges of the present invention, any one or more of the tensile strength, uniform elongation, R/t, and hydrogen embrittlement resistance did not achieve the target.

### Industrial Applicability

According to the present invention, it is possible to provide a cold-rolled steel sheet having excellent formability and excellent hydrogen embrittlement resistance. This steel sheet contributes to a reduction in weight of a vehicle body in a case where the steel sheet is used as a steel sheet for a vehicle, and thus has high industrial applicability.

1. A cold-rolled steel sheet comprising, as a chemical composition, by mass %:
C: more than 0.140% and less than 0.400%;
Si: less than 1.00%;
Mn: more than 2.00% and less than 3.50%;
P: 0.100% or less;
S: 0.010% or less;
A1:0.100% or less;
N: 0.0100% or less;
Ti: 0% or more and less than 0.050%;
Nb: 0% or more and less than 0.050%;
V: 0% or more and 0.50% or less;
Cu: 0% or more and 1.00% or less;
Ni: 0% or more and 1.00% or less;
Cr: 0% or more and 1.00% or less;
Mo: 0% or more and 0.50% or less;
B: 0% or more and 0.0100% or less;
Ca: 0% or more and 0.0100% or less;
Mg: 0% or more and 0.0100% or less;
REM: 0% or more and 0.0500% or less;
Bi: 0% or more and 0.050% or less; and
a remainder: Fe and impurities,
wherein a metallographic structure at a ¼ depth position, which is a ¼ thickness position from a surface, contains, by volume percentage,
retained austenite: more than 1.0% and less than 10.0%,
tempered martensite: 80.0% or more,
ferrite and bainite: 0% or more and 15.0% or less in total, and
martensite: 0% or more and 3.0% or less, and
an average grain size of grains firstly counted in a sheet thickness direction from the surface when viewed at a cross section parallel to a rolling direction and parallel to the sheet thickness direction is 20.0 μm or less, and an average grain size of the grains when the surface is viewed in a plan view is 30.0 μm or less.

2. The cold-rolled steel sheet according to claim 1,
wherein a tensile strength is 1,310 MPa or more, a uniform elongation is 4.0% or more, and R/t, which is a ratio of a limit bend R to a sheet thickness at 90° V-bending is 5.0 or less.

3. The cold-rolled steel sheet according to claim 1,
wherein the chemical composition contains, by mass %, one or more of:
Ti: 0.001% or more and less than 0.050%,
Nb: 0.001% or more and less than 0.050%,
V: 0.01% or more and 0.50% or less,
Cu: 0.01% or more and 1.00% or less,
Ni: 0.01% or more and 1.00% or less,
Cr: 0.01% or more and 1.00% or less,
Mo: 0.01% or more and 0.50% or less,
B: 0.0001% or more and 0.0100% or less,
Ca: 0.0001% or more and 0.0100% or less,
Mg: 0.0001% or more and 0.0100% or less,
REM: 0.0005% or more and 0.0500% or less, and
Bi: 0.0005% or more and 0.050% or less.

4. The cold-rolled steel sheet according to claim 1,
wherein a hot-dip galvanized layer is formed on the surface.

5. The cold-rolled steel sheet according to claim 3,
wherein a hot-dip galvanized layer is formed on the surface.

6. The cold-rolled steel sheet according to claim 4,
wherein the hot-dip galvanized layer is a hot-dip galvannealed layer.

7. The cold-rolled steel sheet according to claim 5,
wherein the hot-dip galvanized layer is a hot-dip galvannealed layer.
